(19) United States
(12) Patent Application Publication
(10) Pub. No.: US 2020/0023859 A1
(43) Pub. Date: Jan. 23, 2020

(54) METHOD FOR PARTIALLY OR FULLY AUTONOMOUSLY DRIVING A MOTOR VEHICLE USING A CONTROL DEVICE, AS WELL AS CONTROL DEVICE AND MOTOR VEHICLE

(71) Applicant: Audi AG, Ingolstadt (DE)

(72) Inventors: Nicholas SCHMITT, Ingolstadt (DE); Stefan MAIWALD, Ingolstadt (DE)

(73) Assignee: Audi AG, Ingolstadt (DE)

(21) Appl. No.: 16/335,386

(22) PCT Filed: Oct. 23, 2017
(86) PCT No.: PCT/EP2017/076973

§ 371 Date: Mar. 21, 2019

(30) Foreign Application Priority Data
Nov. 3, 2016 (DE) 10 2016 221 581.7

(51) Int. Cl. B60W 50/029; B60W 10/18; B60W 10/20; B60W 10/04; B60W 30/18; B60W 50/14

(52) U.S. Cl. CPC B60W 50/029; B60W 10/18; B60W 10/20; B60W 2050/0071; B60W 30/18; B60W 50/14; B60W 10/04

(57) ABSTRACT

The present application relates to a method for autonomous control of a motor vehicle by a control device, wherein the control device is coupled to at least one vehicle component for longitudinal control and/or lateral control of the motor vehicle and provides a regulator unit to generate at least one positioning signal for the at least one vehicle component on the basis of a controller model. The invention provides that a failure regulator model is provided by the control device, by which a failure situation, in which the at least one vehicle component is nonfunctional, is modeled, and a failure signal signaling the failure situation is received from a detection unit during a drive of the motor vehicle, and in dependence on the failure signal, the regulator unit switches over from a standard regulator model, which assumes the at least one vehicle component as functional, to the failure regulator model and the motor vehicle is maneuvered by means of the switched-over regulator unit into a safe state by generating the positioning signals.

### TECHNICAL FIELD

The present application relates to a method for the partially autonomous or fully autonomous control of a motor vehicle by a control device. Depending on the degree of the autonomy (partial autonomy/full autonomy), the control device executes the longitudinal control (steering) and/or lateral control (acceleration and deceleration) instead of a driver. A regulator is provided for this purpose, which generates positioning signals for controlling the motor vehicle by means of a regulator model or regulating algorithm. The present application also includes the control device and a motor vehicle which has the control device.

### BACKGROUND

It can be provided in a motor vehicle that a control device carries out a so-called driving intervention, i.e., if an emergency situation is recognized, it automatically takes over the control of the vehicle if the driver is overwhelmed in the emergency.

For this purpose, it is known from DE 10 2012 001 312 A1 that a driver assistance system recognizes a driving inability of the driver and thereupon automatically effectuates an emergency stop of the motor vehicle.

A method is known from DE 10 2014 006 261 A1 for alleviating an emergency situation, in which a driver assistance system executes a deceleration maneuver of the motor vehicle if it is recognized that the motor vehicle is driverless, because the driver does not keep his hand on the steering wheel, for example.

Monitoring a driver by means of sensor for illness events and activating an autopilot if the driver suffers a heart attack, for example, is known from DE 10 2015 105 581 A1.

The driver assistance systems used in the prior art for autopilot functions are capable of controlling a driverless motor vehicle by means of an autonomous driving maneuver to a predetermined safe state. However, driver assistance systems of this type presume that they are capable with the regulator thereof of controlling the motor vehicle better than the driver himself.

A borderline situation, in which this is not necessarily the case, is damage to the motor vehicle itself, for example, a blown-out tire (tire blowout). If the driver loses control over the vehicle in this case and therefore a control device of a driver assistance system takes over the control of the motor vehicle, this does not necessarily have to result in an improvement of the control behavior, since the regulator unit of the control device generates its positioning signals under the assumption that the motor vehicle behaves properly or as intended. In other words, the regulator unit is not set to changed driving dynamics of the motor vehicle, as are caused by a damaged vehicle component, for example, a tire blowout.

### BRIEF DESCRIPTION OF THE DRAWINGS/FIGURES

FIG. 1 is a schematic illustration of a motor vehicle, in accordance with some embodiments.

FIG. 2 is a sketch to illustrate a failure situation, in accordance with some embodiments.

### DETAILED DESCRIPTION

The present application is based on the object of upgrading a control device for driver assistance in a motor vehicle in such a way that it assists a driver if the driver happens to lose control over the motor vehicle.

The object is achieved by the subjects of the independent patent claims. Advantageous refinements of the present application are described by the dependent patent claims, the following description, and the figures.

In accordance with some embodiments, a method for partially autonomous or fully autonomous control of a motor vehicle is disclosed. The method can be carried out by a control unit or by a control device in general. The control device is coupled for this purpose to vehicle components for longitudinal control and/or transverse control of the motor vehicle. Such a vehicle component can be, for example, a steering system (steering) and/or a traction drive (engine) and/or a brake system (brake). The control device has a regulator unit for generating positioning signals for these vehicle components, in order to generate the positioning signals, for example, in dependence on at least one sensor signal on the basis of a regulator model. Regulator model in this case means the regulating algorithm which the regulator unit executes or carries out to generate the positioning signals. The regulator model can have, for example, a system model of the controlled system, which describes the driving-dynamics behavior of the motor vehicle. For example, such a regulator model can be based on the so-called single-track model of a motor vehicle.

The control device can thus, for example, receive the at least one sensor signal and generate the positioning signals for the vehicle components by means of a standard regulator model, to carry out at least one driving maneuver partially autonomously (for example, only longitudinal control or only lateral control) or fully autonomously (both longitudinal control and also lateral control). Such a standard regulator model describes the vehicle components as fully functional in this case, i.e., every operated vehicle component reacts as intended.

In accordance with some embodiments, a failure regulator model is additionally provided by the control device, by which a failure situation is modeled. The failure situation is characterized in that at least one of the vehicle components is nonfunctional. A vehicle component can be nonfunctional, for example, if it is worn (for example, in the case of brake linings) or damaged, i.e., broken, for example. A positioning signal for such a nonfunctional vehicle component thus has to take into consideration or compensate for a changed component behavior caused by the wear or the damage.

During a drive of the motor vehicle, the control device in accordance with some embodiments can receive a failure signal from a detection unit, which signals a failure situation, i.e., for example, said tire blowout or a broken steering rod. The detection unit can thus detect the failure situation. The control device then switches in its regulator unit from the standard regulator model to the failure regulator model in dependence on the failure signal. The regulator unit thus generates its positioning signals for the vehicle components not on the basis of the standard regulator model, but rather on the basis of the failure regulator model. The changed behavior of the at least one nonfunctional vehicle component is thus taken into consideration in the positioning signals. The control device then maneuvers the motor vehicle by means of the switched-over regulator unit to a predetermined safe state. Since the positioning signals generated for this purpose are adapted to the at least one nonfunctional vehicle component, a mismanagement as a result of an incorrect assumption in the regulator model does not occur in this case.

Accordingly, in the event of changed driving-dynamics behavior of the motor vehicle as a result of at least one nonfunctional vehicle component, the control device can react to this failure situation, while this does not have to be the case with the driver himself, because the driver does not have, for example, the required driving experience for controlling a motor vehicle in this failure situation. For example, in the case of a tire blowout, the driver can thus be assisted in such a way that the control device can maneuver the motor vehicle into the safe state. The control device adapts its regulating behavior in this case to the at least one nonfunctional vehicle component.

The present application also includes advantageous refinements, the features of which result in additional advantages.

As already stated, it is presumed in the case of a control device of a driver assistance system in the prior art that all vehicle components are intact. In contrast, in the failure regulator module for the regulator unit of the control device in accordance with some embodiments, it is preferably provided that this failure regulator model models one of the following failure situations: a broken axle, a tire blowout, a broken strut, an absence of the traction power (i.e., an engine failure), an absence of a braking action (i.e., a failure of the brake system or individual brakes), aquaplaning, uneven tire adhesion (so-called μ-split), and/or worn brakes (i.e., reduced braking power). Such a respective failure situation generally overwhelms a driver of the motor vehicle. Control behavior adapted to the failure situation can thus be provided by a driving intervention of the control device.

In accordance with some embodiments, a changed longitudinal dynamic regulation and/or lateral dynamic regulation is preferably carried out by the regulator unit by the failure regulator model in comparison to the standard regulator model. Switching over of the regulation method or the regulating algorithm is thus performed. The longitudinal dynamics and/or lateral dynamics of the motor vehicle are regulated in this case in consideration of the failure situation.

In accordance with some embodiments, the withdrawal of the control over the motor vehicle from the driver is preferably performed by the method. In other words, in dependence on said failure signal, which signals the failure situation, the control device is activated without driver influence or without an action of the driver. The driver thus does not first have to react in such a way that he activates the control device. This saves time during a reaction to the failure situation.

In accordance with some embodiments, an intervention of the driver, for example, a steering movement or a pedal actuation, is overlaid on the positioning signals of the control device. Alternatively thereto, it is provided that with activated control device, the control over the vehicle is withdrawn from a driver of the motor vehicle by decoupling a steering handle (for example, steering wheel) and/or a pedal set (for example, gas pedal and/or brake pedal). In this way, an incorrect reaction of the driver is prevented from having an effect on the driving behavior of the motor vehicle.

In accordance with some embodiments, the regulating algorithm, which results by way of the failure regulator model, can be derived, for example, from measured reactions of professional drivers or racing drivers. For example, that a behavior of at least one predetermined person is simulated by the failure regulator model. The behavior of multiple predetermined persons can also be simulated, by forming a mean value via driving trajectories which are selected from different persons in a failure situation and have been measured in test drives, for example.

Since the failure regulator model is a regulating algorithm for an emergency situation, it is preferably also provided that the failure regulator model implements a predetermined emergency strategy. For example, it can be provided that the use of a roadside structure of a road for vehicle deceleration is provided by the control device by means of the regulator unit. Thus, for example, a vehicle flank can be guided against a guard rail or the vehicle can be steered onto a median strip, in order to decelerate the motor vehicle in this way.

Up to this point, embodiments have been described in which a predetermined failure situation is signaled by the detection unit. However, in accordance with yet another embodiment, it is preferably provided that one of multiple different failure situations is signaled by the detection unit by means of the failure signal, i.e., the detection unit is provided for detecting multiple different failure situations. A respective failure regulator model for each one of the different failure situations is accordingly provided in each case. A failure regulator model is thus intended or provided for each of the failure situations. The control device accordingly selects one of the failure regulator models in dependence on the failure signal to switch over the regulator unit. The regulator unit thus reacts appropriately to the present failure situation in this way.

In accordance with some embodiments, to be able to carry out the method in a motor vehicle, a control device for partially autonomous or fully autonomous driving operation of the motor vehicle is disclosed. The control device has a processor unit, which is configured to carry out an embodiment of the method as described above. The control device can have at least one microprocessor and/or at least one microcontroller for this purpose. Furthermore, the processor unit can have program code which is configured to carry out the embodiment of the method upon execution by the processor unit. The program code can be stored in a data memory of the processor unit.

In accordance with some embodiments, a motor vehicle is disclosed. The motor vehicle, which has said detection unit for detecting at least one predetermined failure situation, in which at least one vehicle component provided for longitudinal control and/or lateral control of the motor vehicle has become nonfunctional. The motor vehicle furthermore has an embodiment of the control device as described above. The detection unit can be embodied in a way known per se and can have, for example, at least one sensor for detecting the malfunction. The malfunction can also be recognized and signaled, for example, by a control unit of the respective vehicle component in a self-test. The detection unit then represents a distributed device, which is formed by the control units of the vehicle components.

The motor vehicle is preferably designed as an automobile, in particular as a passenger automobile or utility vehicle. In particular, the control device is provided for controlling the motor vehicle with trailer. The at least one vehicle component which can be nonfunctional can then also be part of the trailer.

An exemplary embodiment of the invention is described hereafter. For this purpose, in the figures:

The exemplary embodiment is explained hereafter with reference to drawings. In the exemplary embodiment, the described components of the embodiment each represent individual features to be considered independently of one another, and/or in a combination other than that shown. Furthermore, the described embodiment can also be supplemented by further features as already described herein.

In the figures, functionally-identical elements are each provided with the same reference signs.

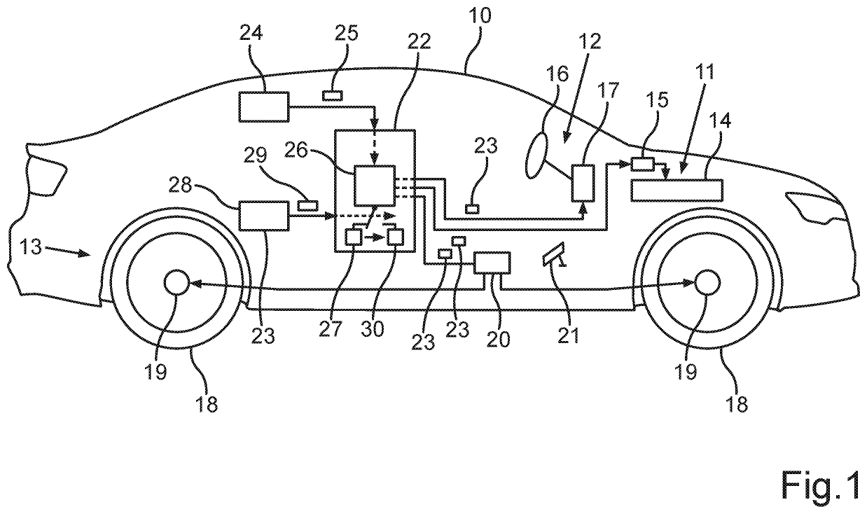

FIG. 1 is a schematic illustration of a motor vehicle, in accordance with some embodiments. FIG. 1 shows a motor vehicle 10, which can be, for example, an automobile, such as a passenger automobile or utility vehicle. The vehicle 10 can pull a trailer, which is not shown in FIG. 1 for the sake of comprehensibility.

A traction drive 11, a steering system 12, and a brake system 13 can be provided in the motor vehicle for controlling the motor vehicle. The traction drive 11 can have at least one drive engine 14 and an associated engine control unit 15. The steering system 12 can have a steering handle 16, for example, a steering wheel, and a steering motor 17, which can set a steering angle on wheels 18 of the motor vehicle 10 independently of the steering handle 16. The brake system 13 can have wheel brakes 19 and a control unit 20 for operating the wheel brakes 19. The traction drive 11, the steering system 12, and the brake system 13 each represent a vehicle component for the longitudinal control (steering system 12 and, in the event of uneven braking, also the brake system 13) and/or for lateral control (brake system 13 and traction drive 11).

A driver (not shown) of the motor vehicle 10 can control the motor vehicle 10 himself by means of the steering handle 16 and a pedal set 21. A control device 22 can additionally carry out a part of the vehicle control (for example, the longitudinal control or the lateral control) or also the entire vehicle control (longitudinal control and lateral control) instead of the driver. For this purpose, the control device 22 can generate at least one positioning signal 23, for example, for the engine control unit 15, the steering motor 17, and/or the brake control unit 20. The control device 22 thus provides driver assistance in the motor vehicle 10.

The control device 22 can be coupled for this purpose to a vehicle sensor system 24, which emits at least one sensor signal 25 to the control device 22. The control device 22 can generate the at least one positioning signal 23 in dependence on the at least one sensor signal 25. The control device 22 can have for this purpose a regulator unit 26 for adjusting, for example, longitudinal dynamics and/or lateral dynamics of the motor vehicle 10. In this way, at least one driving maneuver can be carried out by the control advisor 22. The regulator unit 26 can use a standard regulator model 27, which can describe the driving-dynamic behavior of the motor vehicle 10, for the control of the vehicle 10. An assignment rule or a regulating algorithm is described by the standard regulator model 27, to generate the at least one positioning signal 23 in dependence on the at least one sensor signal 25.

In the motor vehicle 10, it can additionally be ensured that the regulator unit 26 of the control device 22 reacts adequately or appropriately to a failure situation, in which at least one vehicle component, i.e., the traction drive 11 and/or the steering system 12 and/or the brake system 13, displays a failure, for example, because the drive engine 14, a steering rod of the steering system 12, and/or one or more wheel brakes 19 becomes nonfunctional as a result of wear or damage, i.e., cannot be actuated as intended or does not react as intended.

The failure situation of at least one vehicle component can be determined in the motor vehicle 10 by a detection unit 28 in a way known per se, for example, on the basis of sensors and/or self-tests. The detection unit 28 can signal a detected failure situation to the control device 22 by means of a failure signal 28. The control device 22 can be switched over from the standard regulator model 27 to a failure regulator model 30 in dependence on the failure signal 29. In the control device 22, the regulator unit 26 now uses the failure regulator model 30 to generate the at least one positioning signal 23 in dependence on the at least one sensor signal 25. The failure regulator model 30 thus replaces the standard regulator model 27 in the failure situation.

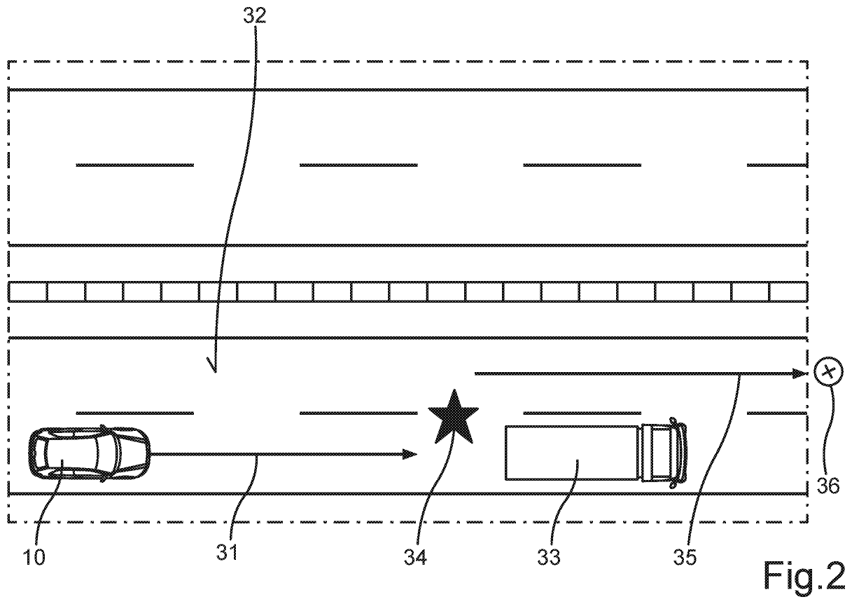

FIG. 2 is a sketch to illustrate a failure situation, in accordance with embodiments. FIG. 2 shows the motor vehicle 10 during a drive 31 on a road 32. The vehicle 10 can approach an external vehicle 33 for a passing maneuver. The motor vehicle 10 can be controlled in this case by the control device 22, for example, fully autonomously on the basis of the standard regulator model 27 or also partially autonomously. Driving exclusively by the driver 10 (so-called manual driving) can also be provided. During the passing maneuver, for example, a failure 34 of a vehicle component can occur. The failure 34 then represents a failure situation.

The failure 34 can be detected by the detection unit 28 and signaled accordingly by the failure signal 29 of the control device 22. The control advisor 22 can switch over to the failure regulator model 30, whereupon the motor vehicle 10 can be maneuvered or controlled by the control device 22. A safeguard maneuver 35 can be provided, for example, swerving past the external vehicle 33 and decelerating the motor vehicle 10 to achieve a predetermined safe state 36, for example, the standstill of the motor vehicle 10, in spite of the failure 34.

If an unpredicted situation occurs in the motor vehicle 10, namely a failure situation, for example, a tire blowout or aquaplaning or μ-split, the control device 22 takes over the control of the motor vehicle 10 to adjust longitudinal dynamics and/or lateral dynamics. This stabilizes and decelerates the motor vehicle 10 to the standstill as a possible safe state 36. The stabilization can take place, for example, by selective activation of the individual wheel brakes 19. Moreover, emergency strategies may be implemented, for example, the usage of a guardrail for vehicle braking in case of emergency. The takeover of the control of the motor vehicle 10 by the control device 22 can be achieved, for example, by withdrawing the controls, i.e., the pedal set 21 and/or the steering handle 16, from the vehicle controller or driver. However, an option can also be provided that the driver engages in the control of the motor vehicle 10 again.

This assistance function can be implemented in an already installed control unit or as a separate control unit, which then represents the control device 22 in each case. The regulating algorithm, as is implemented by the failure regulator model 30, can be derived from measured reactions of professional drivers or racing drivers for this emergency assistance function.

During the failure situation, for example, having autonomous stabilization and braking phase, in dependence on the failure 34, an emergency call can moreover also be made and/or a speech connection to an emergency office can be established by means of a mobile wireless system of the motor vehicle 10 and/or a smart phone coupled to the motor vehicle 10.

Since the driver is not capable of reacting adequately in failure situations or emergency situations, for example, a tire blowout or aquaplaning or μ-split, the control device 22 reacts automatically to this failure situation. The described emergency assistance function of the control device 22 provides specialized regulating behavior by means of the failure regulator module 30 for this purpose. The control device 22 can provide in this case a failure regulator model 30 for the control of the passenger automobile or utility vehicle having trailer.

The described failures 34 are so-called internal emergency causes, which could thus relate to a malfunction of at least one vehicle component, so that a standard regulator model 27 could not provide an adequate positioning signal 23, since the standard regulator model 30 does not take into consideration the changed or modified driving-dynamic behavior of the motor vehicle 10. Only switching over to a failure regulator model 30 makes it possible for the control unit 22 to be able to still stabilize the motor vehicle 10 by means of the regulating unit 26 and/or be able to adjust longitudinal dynamics and/or lateral dynamics to a predetermined target profile.

Overall, the example shows how an autonomous emergency assistant can be provided in a motor vehicle.

1-10. (canceled)

11. A method, comprising:
receiving, at a regulator unit of a control device, at least one sensor signal for at least one component of a motor vehicle;
detecting, at a detection unit of the control device, a failure situation;
receiving, at the regulator unit from the detection unit, a failure signal associated with the failure situation; and
generating, at the regulator unit, a positional signal for the at least one component of the motor vehicle for maneuver control of the motor vehicle to move the motor vehicle at a predetermined safe state,
wherein the control device is coupled to the at least one component of the motor vehicle.

12. The method of claim 11, wherein the at least one component of the motor vehicle components is one of: a steering system, a brake system, and a traction system.

13. The method of claim 11, wherein the generating of the positional signal is based on a regulator model comprising information related to a driving behavior of the motor vehicle, wherein the at least one component is functional.

14. The method of claim 11, wherein the generating of the positional signal is based on a failure regulator model comprising information adapted to the at least one component of the motor vehicle, where in the at least one component is nonfunctional.

15. The method of claim 11, further comprising generating the positional signal for a longitudinal control or a lateral control of the motor vehicle.

16. The method of claim 11, wherein the failure situation is at least one of: a broken axle, a tire blowout, a broken strut, an absence of a traction power, an absence of a braking action, an aquaplaning, an uneven tire adhesion, and a worn brake.

17. The method of claim 11, further comprising activating the control device in response to the failure signal received at the regular unit and without intervention of a driver of the motor vehicle.

18. The method of claim 17, further comprising in response to the activated control device, withdrawing control of a driver of the motor vehicle by decoupling a steering handle, a brake pedal or a gas pedal.

19. The method of claim 14, wherein the failure regulator model further comprises a behavior of at least one predetermined person.

20. The method of claim 14, wherein the failure regulator model further comprises a predetermined emergency strategy comprising a usage of roadside structures of a road to decelerate the motor vehicle.

21. The method of claim 11, further comprising identifying, at the regulator unit, the failure situation based on the failure signal; and selecting a failure regulator model based on the identified failure situation to generate the positional signal.

22. A control device, comprising:
a memory; and
at least one processor operative to access the memory and perform operations comprising:
receiving at least one sensor signal for at least one component of a motor vehicle;
detecting a failure situation;
receiving a failure signal associated with the failure situation; and
generating a positional signal for the at least one component of the motor vehicle for maneuver control of the motor vehicle to move the motor vehicle at a predetermined safe state,
wherein the control device is coupled to the at least one component of the motor vehicle.

23. The control device of claim 22, wherein the at least one component of the motor vehicle components is one of: a steering system, a brake system, and a traction system.

24. The control device of claim 22, wherein the generating of the positional signal is based on a regulator model comprising information related to a driving behavior of the motor vehicle, wherein the at least one component is functional.

25. The control device of claim 22, wherein the generating of the positional signal is based on a failure regulator model comprising information adapted to the at least one component of the motor vehicle, where in the at least one component is nonfunctional.

26. The control device of claim 22, wherein the operations further comprising: generating the positional signal for a longitudinal control or a lateral control of the motor vehicle.

27. A motor vehicle, comprising:
a detection unit; and
a control device comprising:
a memory; and
at least one processor operative to access the memory and perform operations comprising:
receiving at least one sensor signal for at least one component of the motor vehicle;
detecting a failure situation;
receiving a failure signal associated with the failure situation; and
generating a positional signal for the at least one component of the motor vehicle for maneuver control of the motor vehicle to move the motor vehicle at a predetermined safe state,
wherein the control device is coupled to the at least one component of the motor vehicle.

28. The motor vehicle of claim 27, wherein the at least one component of the motor vehicle components is one of: a steering system, a brake system, and a traction system.

29. The motor vehicle of claim 27, wherein the control device is further configured to generate the positional signal based on a regulator model comprising information related to a driving behavior of the motor vehicle, wherein the at least one component is functional.

30. The motor vehicle of claim 27, the control device is further configured to generate the positional signal based on a failure regulator model comprising information adapted to the at least one component of the motor vehicle, where in the at least one component is nonfunctional.
